(19) United States
(12) Patent Application Publication
(10) Pub. No.: US 2008/0136781 A1
(43) Pub. Date: Jun. 12, 2008

(54) Dual light sources mouse capable of controlling the on and off state of the second light source

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,853

(22) Filed: Dec. 7, 2006

(51) Int. Cl. G09G 5/08

(52) U.S. Cl. 345/166

(57) ABSTRACT

A dual light sources mouse capable of controlling the on and off state of the second light source is proposed. The dual light sources mouse includes a first sensor unit, a first light emitting unit, a microprocessor unit, a second sensor unit and a second light emitting unit. The dual light sources mouse is an optical mouse with a pair of sensor units. The first sensor unit analyzes the motion state of the mouse by collocating with the first light emitting unit, and then the microprocessor unit controls the on and off state of the second light unit which is collocated with the second sensor unit. The second light unit (for instance: a laser diode) can thus be turned off to ensure the security in use while the dual light sources mouse is in the static state.

### BACKGROUND OF THE INVENTION

1. Field of the Invention

The present invention relates to an optical mouse and a light source control method thereof and, more particularly, to a dual light sources mouse capable of controlling the on and off of the second light source and a light source control method thereof.

2. Description of Related Art

With continual progress of science and technology, computer mice have evolved from early mechanical type to present optical type. Earlier optical mice must be operated on a special mouse pad having coordinated grids thereon. In more recent optical LED mice, this problem has been improved, but their use is still limited by the material used by the interface for reflecting the light source. If the optical LED mice are used on a reflecting place that will absorb light, transmit light or disturb the reflection of light, they cannot be accurately used for click browsing and operation.

In order to solve the above drawbacks in the use of optical LED mice and further enhance the resolution, optical laser mice have been proposed. Based on the coherence characteristic of laser light, image of high contrast can be produced to solve the material problem of the reflection surface and also greatly enhance the resolution.

It should be noted that although light emitting units used by optical mice conform with the safety standard, users still should avoid direct view to ensure the safety, especially for optical laser mice. As shown in FIG. 1, an existent optical laser mouse comprises a laser-stream sensor 10a and a laser light source 20a, but has no mechanism for turning off its light source (a laser diode). Therefore, there is safety doubt in the use of conventional optical laser mice.

### SUMMARY OF THE INVENTION

An object of the present invention is to provide a dual light sources mouse capable of controlling the on and off state of the second light source. Through the design of dual light sources, the on and off state of the second light emitting unit of the dual light sources mouse can be controlled.

To achieve the above object, the present invention provides a dual light sources mouse capable of controlling the on and off state of the second light source. The dual light sources mouse comprises a first sensor unit, a first light emitting unit, a second sensor unit, a second light emitting unit and a microprocessor unit. The first light emitting unit is electrically connected to the first sensor unit, and is used to provide a light source of reflected shadow required when the first sensor unit analyzes images. The first sensor unit will output a detection signal to the microprocessor unit. The microprocessor unit then outputs a light source control signal to control a laser driver unit in the second sensor unit for controlling the on and off state of the second light emitting unit according to the detection signal. The first sensor unit is an optical positioning sensor. The first light emitting unit is an LED. The second sensor unit is a laser-stream sensor. The second light emitting unit is a laser diode.

The present invention also provides a method for controlling the on and off state of the second light source of a dual light sources mouse. The method comprises the steps of: determining whether the mouse has moved according to the analysis of image variation; outputting a static reference signal to the microprocessor unit if the mouse has been determined to have not moved; the microprocessor unit outputting a light source off signal to the laser driver unit according to the static reference signal; turning off the laser driver unit to let the second light emitting unit stop emitting a light source; outputting a motion signal to the microprocessor unit if the mouse has been determined to have moved; the microprocessor unit outputting a light source on signal to the laser driver unit according to the motion signal; and activating the laser driver unit to turn on the second light emitting unit to emit light.

To achieve the above object, the present invention also provides a dual light sources mouse capable of controlling the on and off state of the second light source. The dual light source comprises a first light emitting unit, a first sensor unit, a second light emitting unit, a second sensor unit and a microprocessor unit. The first sensor unit is electrically connected to the first light emitting unit, and is used to analyze received surface characteristics so as to output a first surface characteristics signal according to the reflected shadow image caused by the first light emitting unit. The second sensor unit is electrically connected to the second light emitting unit, and is used to analyze received surface characteristics so as to output a second surface characteristics signal according to the reflected shadow image caused by the second light emitting unit. The microprocessor is used to receive and compare the first and second surface characteristics signals and output a light source control signal to control the on and off state of a laser driver unit in the second sensor unit.

The present invention also provides a method for controlling the on and off state of the second light source of a dual light sources mouse. The method comprises the steps of: using a first sensor unit to receive and analyze surface characteristics so as to output a first surface characteristics signal; using a second sensor unit to receive and analyze surface characteristics so as to output a second surface characteristics signal; using a microprocessor unit to receive the first and second surface characteristics signals and determine whether the first and second surface characteristics signals conform to a reference level for turning off the light source; the microprocessor unit outputting a light source off signal to turn off a laser driver unit so as to let a second light emitting unit stop emitting a light source if the answer is yes; and the microprocessor unit outputting a light source on signal to activate the laser driver unit so as to turn on the second light emitting unit to emit light if the answer is no.

### BRIEF DESCRIPTION OF THE DRAWINGS

The various objects and advantages of the present invention will be more readily understood from the following detailed description when read in conjunction with the appended drawing, in which:

FIG. 1 is an upward view of a laser optical mouse in the prior art;

FIG. 2A is a block diagram of a dual light sources mouse capable of controlling the on and off state of the second light source according to a preferred embodiment of the present invention;

FIG. 2B is an upward view of a dual light sources mouse capable of controlling the on and off state of the second light source of the present invention;

FIG. 3 is a flowchart of a method for controlling the on and off state of the second light source of a dual light sources mouse according to a preferred embodiment of the present invention; and

FIG. 4 is a flowchart of a method for controlling the on and off state of the second light source of a dual light sources mouse according to another preferred embodiment of the present invention.

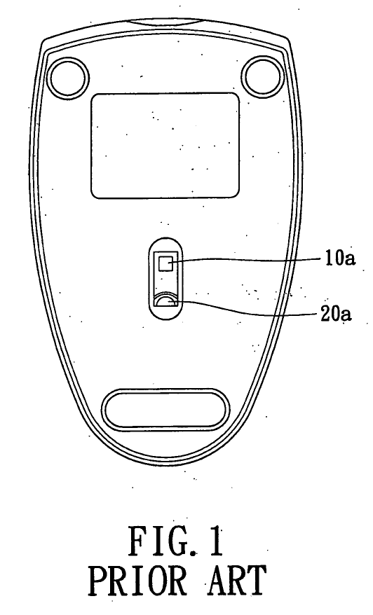

### DETAILED DESCRIPTION OF THE PREFERRED EMBODIMENTS

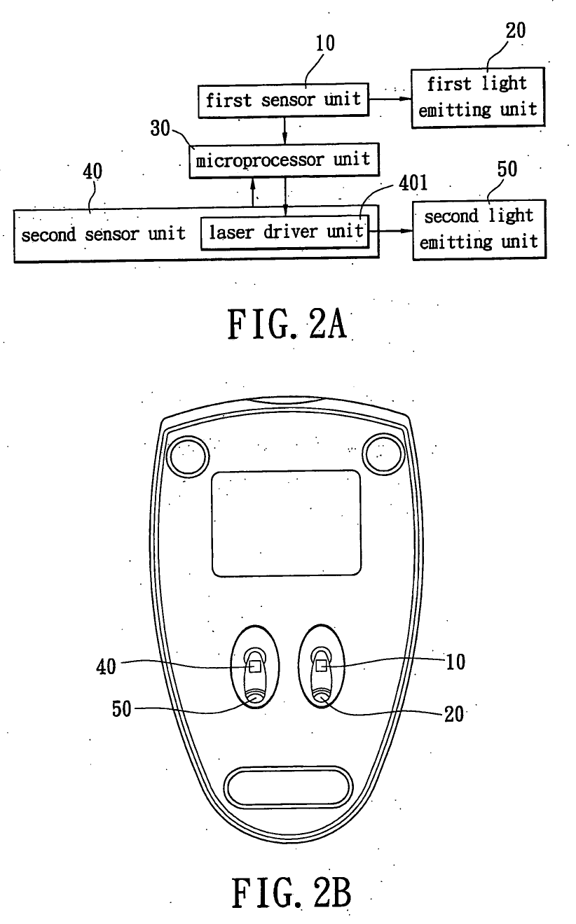

As shown in FIGS. 2A and 2B, the present invention provides a dual light sources mouse capable of controlling the on and off state of the second light source. The dual light sources mouse comprises a first sensor unit 10, a first light emitting unit 20, a microprocessor unit 30, a second sensor unit 40 and a second light emitting unit 50. The second sensor unit 40 further comprises a laser driver unit 401.

The first sensor unit 10 is an optical positioning sensor, and is used to analyze the variation of image motion to output a detection signal. The detection signal is a motion signal or a static reference signal. The first light emitting unit 20 is an LED, and provides a first light source of reflected shadow required when the first sensor unit analyzes images. The microprocessor unit 30 is used to output a light source control signal according to the detection signal provided by the first sensor unit 10. If the detection signal is the motion signal, the light source control signal is a light source on signal. Contrarily, if the detection signal is the static reference signal, the light source control signal is a light source off signal. The light source control signal is used to control the on and off state of the laser driver unit 401 in the second sensor unit 40 to turn on or off the second light emitting unit 50. The laser driver unit 401 can be an electronic circuit. The second light emitting unit 50 is a laser diode for providing a second light source. Moreover, the second sensor unit 40 is a laser-stream sensor that calculates the image motion vector and rate to reflect the motion locus of the mouse cursor (i.e., the operation of the mouse cursor) based on the reflected shadow image of the second light source emitted by the second light emitting unit 50.

Therefore, the first sensor unit 10 and the first light emitting unit 20 are always on, and are specially in charge of realtime discrimination of the moving or static state of the mouse to send out the detection signal. The second sensor unit 40 and the second light emitting unit 50 respond to the motion locus of the mouse cursor (i.e., the operation of the mouse cursor). The on and off state of the second light emitting unit 50 is controlled by the light source control signal output by the microprocessor 30.

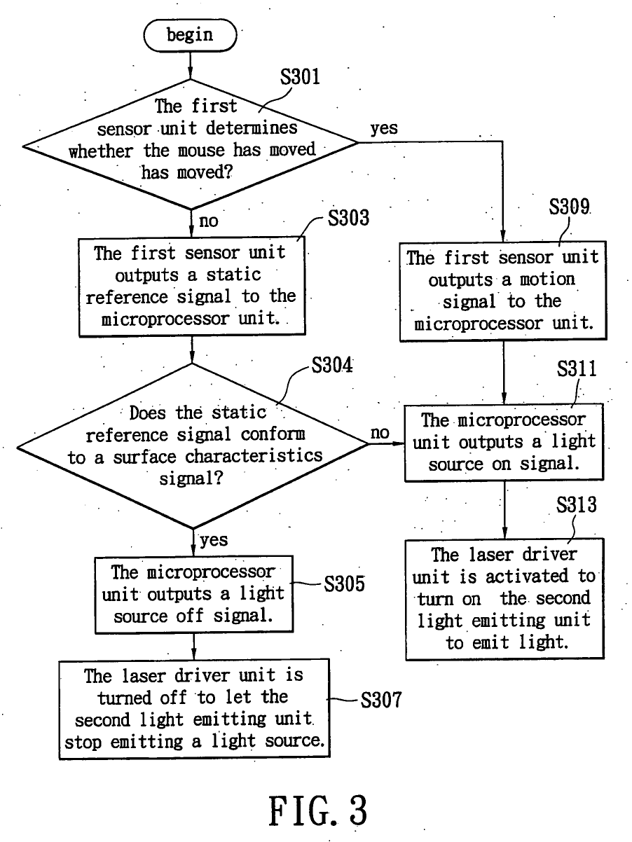

As shown in FIG. 3, the present invention provides a method for controlling the on and off state of the second light source of a dual light sources mouse. The method comprises the following steps. First, a first sensor unit 10 is used to analyze the variation of reflected shadow image to determine whether the mouse has moved (Step S301). The first sensor unit 10 is an optical positioning sensor. If the answer is no, the first sensor unit 10 outputs a static reference signal to a microprocessor 30 (Step S303). The microprocessor unit 30 then compares a surface characteristics signal collected by a second sensor unit 40 according to the static reference signal provided by the first sensor unit 10 (Step S304). If the surface characteristics signal is determined to conform to the static reference signal, the microprocessor unit 30 outputs a light source off signal to a laser driver unit 401 in the second sensor unit 40 (Step S305). The laser driver unit 401 then lets a second light emitting unit 50 stop emitting a light source (Step S307). If the answer in Step S301 is yes, the first sensor unit 10 outputs a motion signal to the microprocessor unit 30 (Step S309). The microprocessor unit 30 then outputs a light source on signal to the laser driver unit 401 according to the motion signal provided by the first sensor unit 10 (Step S311). The laser driver unit 401 is thus activated to turn on the second light emitting unit 50 to emit light (Step S313). If the surface characteristics signal is determined to not conform to the static reference signal in Step S304, Step S311 is jumped to for outputting a laser-on signal. The laser driver unit 401 can be an electronic circuit in the second sensor unit 40. The second light emitting unit 50 can be a laser diode.

Besides, in the above description, the first sensor unit 10 and the first light emitting unit 20 are always on, and are only used for realtime discrimination of the moving or static state of the mouse. When the mouse is under operation and the first sensor unit 10 detects image motion, the first sensor unit 10 will provide a motion signal to the microprocessor unit 30. The microprocessor unit 30 then outputs a light source on signal to activate the laser driver unit 401, which turns on the second light emitting unit 50 to emit light. At this time, the second sensor unit 40 can accurately calculates the motion vector and rate to ensure normal operation of the mouse cursor. Contrarily, if the mouse is static or the mouse is overturned, the first sensor unit 10 analyzes the variation of image motion and determines it to be static, the first sensor unit 10 will provide a static reference signal to the microprocessor unit 30. The microprocessor unit 30 then outputs a light source off signal to turn off the laser driver unit 401 so as to let the second light emitting unit 50 stop emitting light, thereby preventing the user from eye damage caused by direct view of the second light emitting unit 50.

Reference is made to FIG. 2A again. The present invention also provides another preferred embodiment of the dual light sources mouse capable of controlling the on and off state of the second light source. The dual light sources mouse comprises a first sensor unit 10, a first light emitting unit 20, a microprocessor unit 30, a second sensor unit 40 and a second light emitting unit 50. The second sensor unit 40 further comprises a laser driver unit 401. The laser driver unit 401 is electrically connected to the second sensor unit 40, and can be an electronic circuit. The first sensor unit 10 is electrically connected to the first light emitting unit 20, and is used to analyze surface characteristics received by the first sensor unit 10 so as to output a first surface characteristics signal according to the reflected shadow image of the first light source provided by the first light emitting unit 20. The second sensor unit 40 is electrically connected to the second light emitting unit 50, and is used to analyze surface characteristics received by the second sensor unit 40 so as to output a second surface characteristics signal according to the reflected shadow image of the second light source provided by the second light emitting unit 50. The first sensor unit 10 is an optical positioning sensor, and the second sensor unit 40 is a laser-stream sensor. The first light emitting unit 20 is an LED, and the second light emitting unit 50 is a laser diode.

The microprocessor unit 30 is used to receive and compare the first and second surface characteristics signals to output a light source control signal for controlling the on and off state of the laser driver unit 401. Besides, the second sensor unit 40 calculates the image motion vector and rate to reflect the motion locus of the mouse cursor based on the reflected shadow image of the second light source emitted by the second light emitting unit 50.

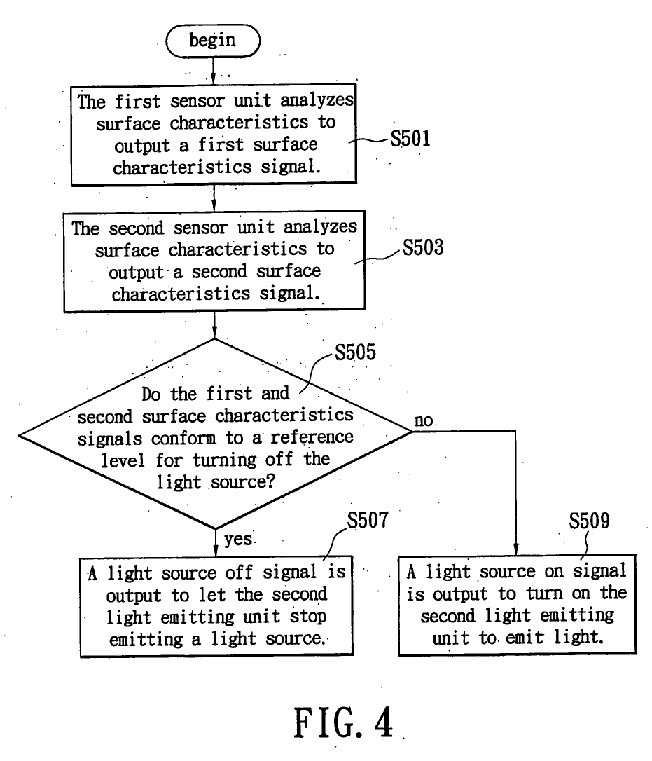

As shown in FIG. 4, the present invention provides another preferred embodiment of the method for controlling the on and off state of the second light source of a dual light sources mouse. The method comprises the following steps. First, a first sensor unit 10 is used to receive and analyze surface characteristics so as to output a first surface characteristics signal (Step S501).

Next, a second sensor unit 40 is used to receive and analyze surface characteristics so as to output a second surface characteristics signal (Step S503). A microprocessor unit 30 is then used to receive the first and second surface characteristics signals and determine whether the first and second surface characteristics signals conform to a reference level for turning off the light source (Step S505). If the answer is yes, the microprocessor unit 30 outputs a light source off signal to turn off a laser driver unit 401 so as to let a second light emitting unit 50 stop emitting a light source (Step S507). If the answer is no, the microprocessor unit 30 outputs a light source on signal to activate the laser driver unit 401 so as to turn on the second light emitting unit 50 to emit light (Step S509). The first sensor unit 10 is an optical positioning sensor, and is always on. The laser driver unit 401 can be an electronic circuit in the second sensor unit 40, and is used to control the second light emitting unit 50. The second light emitting unit 50 can be a laser diode.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A dual light sources mouse capable of turning on and off the second light source comprising:
a first light emitting unit for providing a first light source;
a first sensor unit electrically connected to said first light emitting unit, said first sensor unit analyzing the variation of image motion to output a detection signal based on the reflected shadow image caused by said first light source;
a microprocessor unit for outputting a light source control signal based on said detection signal;
a second light emitting unit for providing a second light source; and
a second sensor unit further comprising a laser driver unit, said laser driver unit being electrically connected to said second light emitting unit, said laser driver unit controlling the on and off state of said second light emitting unit according to said light source control signal.

2. The dual light sources mouse as claimed in claim 1, wherein said first light emitting unit is a light emitting diode (LED).

3. The dual light sources mouse as claimed in claim 1, wherein said first sensor unit is an optical positioning sensor.

4. The dual light sources mouse as claimed in claim 1, wherein said detection signal is a motion signal or a static reference signal.

5. The dual light sources mouse as claimed in claim 4, wherein said motion signal lets said microprocessor unit output a light source on signal, while said static reference signal lets said microprocessor output a light source off signal.

6. The dual light sources mouse as claimed in claim 1, wherein said second light emitting unit is a laser diode.

7. The dual light sources mouse as claimed in claim 1, wherein said second sensor unit is a laser-stream sensor.

8. The dual light sources mouse as claimed in claim 1, wherein said second sensor unit calculates the image motion vector and rate to reflect the motion locus of the mouse cursor based on the reflected shadow image caused by said second light source.

9. The dual light sources mouse as claimed in claim 1, wherein said laser driver unit is an electronic circuit.

10. A method for controlling the on and off state of the second light source of a dual light sources mouse, said method comprising the steps of:
(a) using a first sensor unit to analyze the variation of image motion so as to determine whether said mouse has moved;
(b) outputting a static reference signal to a microprocessor unit if the answer in step (a) is no;
(c) said microprocessor unit outputting a light source off signal to a laser driver unit according to said static reference signal;
(d) turning off said laser driver unit to let a second light emitting unit stop emitting a light source;
(e) outputting a motion signal to said microprocessor unit if the answer in step (a) is yes;
(f) said microprocessor unit outputting a light source on signal to said laser driver unit according to said motion signal; and
(g) activating said laser driver unit to turn on said second light emitting unit to emit light.

11. The method as claimed in claim 10, wherein said first sensor unit is an optical positioning sensor.

12. The method as claimed in claim 10, wherein said first sensor unit is always on to analyze the variation of image in real time.

13. The method as claimed in claim 10, wherein said microprocessor unit compares whether said static reference signal conforms to a surface characteristics signal collected by a second sensor unit in step (c), and said microprocessor unit outputs said light source off signal if the answer is yes.

14. The method as claimed in claim 13, wherein if said static reference signal does not conform to said surface characteristics signal, said microprocessor outputs said light source on signal.

15. The method as claimed in claim 10, wherein said laser driver unit is an electronic circuit belonging to a second sensor unit.

16. The method as claimed in claim 10, wherein said second light emitting unit is a laser diode.

17. A dual light sources mouse capable of turning on and off the second light source comprising:
a first light emitting unit for providing a first light source;
a first sensor unit electrically connected to said first light emitting unit, said first sensor unit analyzing surface characteristics received by said first sensor unit to output a first surface characteristics signal based on the reflected shadow image caused by said first light source;
a microprocessor unit for outputting a light source control signal based on said detection signal;
a second light emitting unit for providing a second light source;
a second sensor unit analyzing surface characteristics received by said second sensor unit to output a second surface characteristics signal based on the reflected shadow image caused by said second light source, said second sensor unit further comprising a laser driver unit, said laser driver unit being electrically connected to said second light emitting unit; and
a microprocessor unit used to receive and compare said first and second surface characteristics signals so as to output a light source control signal for controlling the on and off state of said laser driver unit.

18. The dual light sources mouse as claimed in claim 17, wherein said first light emitting unit is a light emitting diode (LED).

19. The dual light sources mouse as claimed in claim 17, wherein said first sensor unit is an optical positioning sensor.

20. The dual light sources mouse as claimed in claim 17, wherein said second light emitting unit is a laser diode.

21. The dual light sources mouse as claimed in claim 17, wherein said second sensor unit is a laser-stream sensor.

22. The dual light sources mouse as claimed in claim 17, wherein said second sensor unit calculates the image motion vector and rate to reflect the motion locus of the mouse cursor based on the reflected shadow image caused by said second light source.

23. The dual light sources mouse as claimed in claim 17, wherein said laser driver unit is an electronic circuit.

24. A method for controlling the on and off state of the second light source of a dual light sources mouse, said method comprising the steps of:
using a first sensor unit to receive and analyze surface characteristics so as to output a first surface characteristics signal;
using a second sensor unit to receive and analyze surface characteristics so as to output a second surface characteristics signal;
using a microprocessor unit to receive said first and second surface characteristics signals and determine whether said first and second surface characteristics signals conform to a reference level for turning off the light source;
said microprocessor unit outputting a light source off signal to turn off a laser driver unit so as to let a second light emitting unit stop emitting a light source if the answer is yes; and
said microprocessor unit outputting a light source on signal to activate said laser driver unit so as to turn on said second light emitting unit to emit light if the answer is no.

25. The method as claimed in claim 24, wherein said first sensor unit is an optical positioning sensor.

26. The method as claimed in claim 24, wherein said first sensor unit is always on.

27. The method as claimed in claim 24, wherein said laser driver unit is an electronic circuit belonging to a second sensor unit.

28. The method as claimed in claim 24, wherein said second light emitting unit is a laser diode.
